(19) United States
(12) Patent Application Publication
(10) Pub. No.: US 2012/0125494 A1
(43) Pub. Date: May 24, 2012

(54) THEFT PROTECTABLE CARRYING BAG IN PARTICULAR FOR PORTABLE COMPUTERS

(76) Inventor: Meir Avganim, M.P. Nachal Sorek (IL)

(21) Appl. No.: 13/262,952

(22) PCT Filed: Mar. 10, 2010
(86) PCT No.: PCT/IL2010/000194

§ 371 Date: Feb. 7, 2012

(30) Foreign Application Priority Data
Apr. 6, 2009 (IL) 198038

(51) Int. Cl. A45C 13/18; A45C 13/10; A45C 3/00; A45C 13/20

(52) U.S. Cl. 150/101

(57) ABSTRACT

A carrying bag (10) with a shoulder-strap (22) and a zipper (14) with zipper-rider (16) for closing/opening the bag. The shoulder-strap (22) is provided with a loop (24) at one end and a key-operated locking device (26) at the other end thereof. Means (36) are provided for fastening the loop (24) to an inside wall of the bag. Means (48) are provided for securing the zipper-rider (16) by the locking device (26) to an outside wall of the bag (10) for preventing the un-zipping of the bag.

### FIELD OF THE INVENTION

The present invention generally relates to carrying bags for valuables, particularly portable computers or the like equipment items of considerable value.

### BACKGROUND OF THE INVENTION

Many innovations have been developed in order to protect table- and portable-computers against theft or “snatching”: see for example U.S. Pat. Nos. 6,244,082, 7,100,403, 7,111,479.

The most common laptop anti-theft devices are based on a security, steel cable, looped about itself at one end so as to become tied around a table-leg or similar immovable object, whereas the other end is provided with any of various models of key-operated, combination or other types of locks. Mostly, the locking devices were adapted to be secured against a rectangular slot formed (by the manufacturers) at a side wall of the portable computer (sometimes called “designated slot”).

Less attention has been dedicated to the protection of side-bags, attaches and trolleys, specifically designed for carrying laptops, that became so vastly used all-over the globe.

It is therefore a major object of the present invention to offer a solution to the problem of stealing portable computers while stored is their transportation facilities, e.g. bags left momentarily unattended in public or semi-public places.

It is a further object of the invention to employ the normally available shoulder-strap of carrying bags as means for securing the bag to an immovable object.

It is a still further object of the invention to equip such shoulder-straps with any of the above-mentioned locking devices so as to be used alternatively to lock the normally available zipper(s) to the bag after being tied to an immovable object, or to function as self-contained means for securing a laptop by its designated slot.

### SUMMARY OF THE INVENTION

According to the present invention there is provided a carrying bag with shoulder-strap and zipper with at least one zipper-rider for closing/opening the bag, the shoulder-strap being provided with a loop at one end and a key-operated locking device at the other end thereof, means for fastening the loop to an inside wall of the bag, and means for securing said at-least one zipper-rider by said locking device to an outside wall of the bag for preventing the un-zipping of the bag.

### BRIEF DESCRIPTION OF THE DRAWINGS

These and additional constructional features and advantages of the present invention will become more readily understood in the light of the ensuing description of preferred embodiments thereof, given by way of example only, with reference to the accompanying drawings, wherein—

FIG. 1 is a perspective view, partly in cross-section of a carrying bag with shoulder-strap presenting some of the characteristic features of the invention according to a preferred embodiment thereof;

FIG. 2 shows a shoulder-strap such as used in the embodiment of FIG. 1;

FIG. 3a illustrates a preparatory stage of arresting the bag against a fixed object;

FIG. 3b shows the completion of the stage of FIG. 3a;

FIG. 4a depicts the shoulder-strap of FIG. 2 used for arresting a portable computer against a fixed object according to another aspect of the invention;

FIG. 4b shows the function of the designated slot in the embodiment of FIG. 4a;

FIG. 4c shows the bag of FIG. 1 when the shoulder strap is separately used as in FIG. 4a; and

FIG. 5 illustrates the application of the shoulder-strap locking device for securing a pair of zipper-riders.

### DETAILED DESCRIPTION OF THE PREFERRED EMBODIMENTS

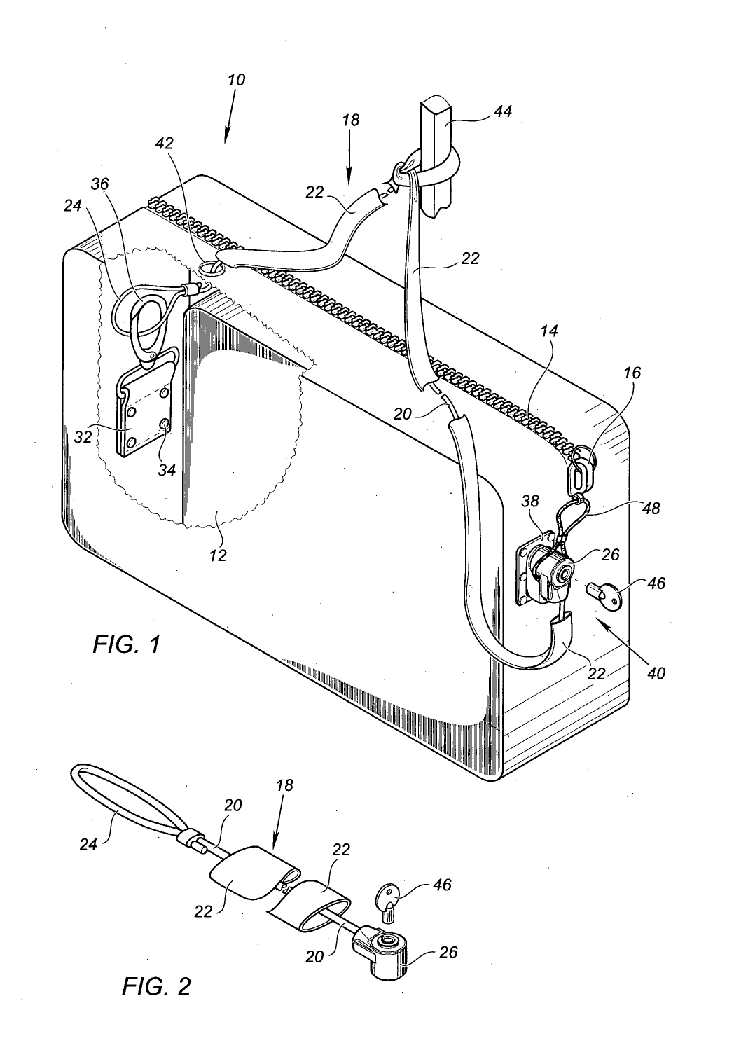

In FIG. 1 there is shown a typical laptop computer carrying bag. The bag generally denoted 10, with computer 12 inside, is closed by zipper 14 having zipper rider 16.

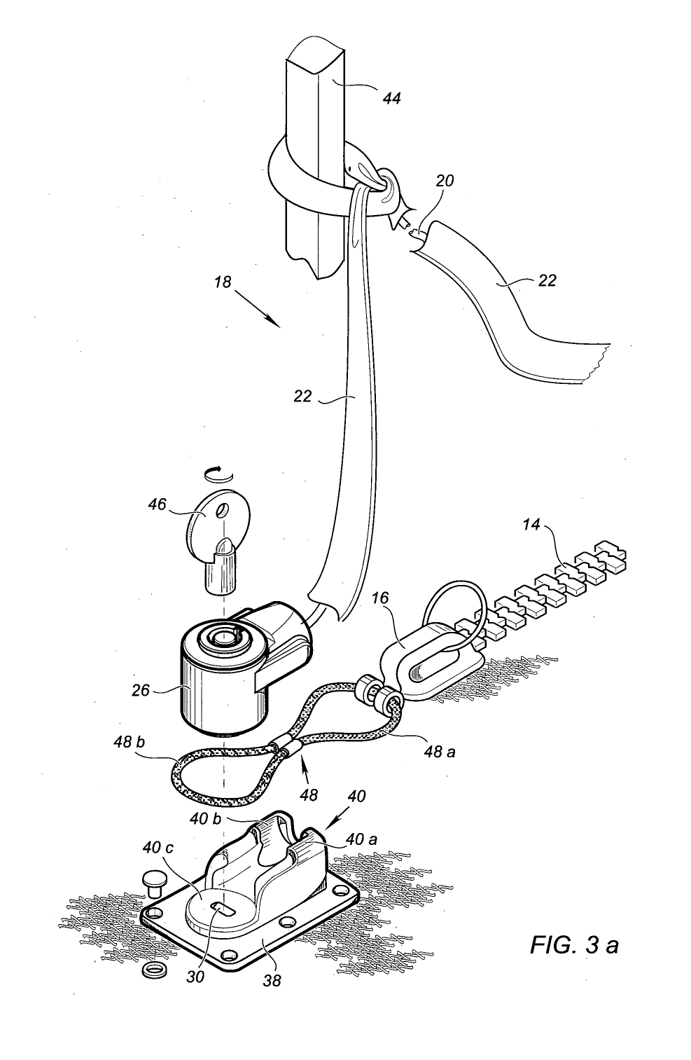

A specially designed shoulder-strap 18 is provided (see also FIG. 2). In the exemplified embodiment, a steel-cable 20 is used, passing through an external sheath 22. More advisable, the sheath proper can be made of cloth or canvas, armored by metal or strong plastic threads or fibers woven in the material of the strap.

At one end of the cable 20 a closed loop 24 is formed.

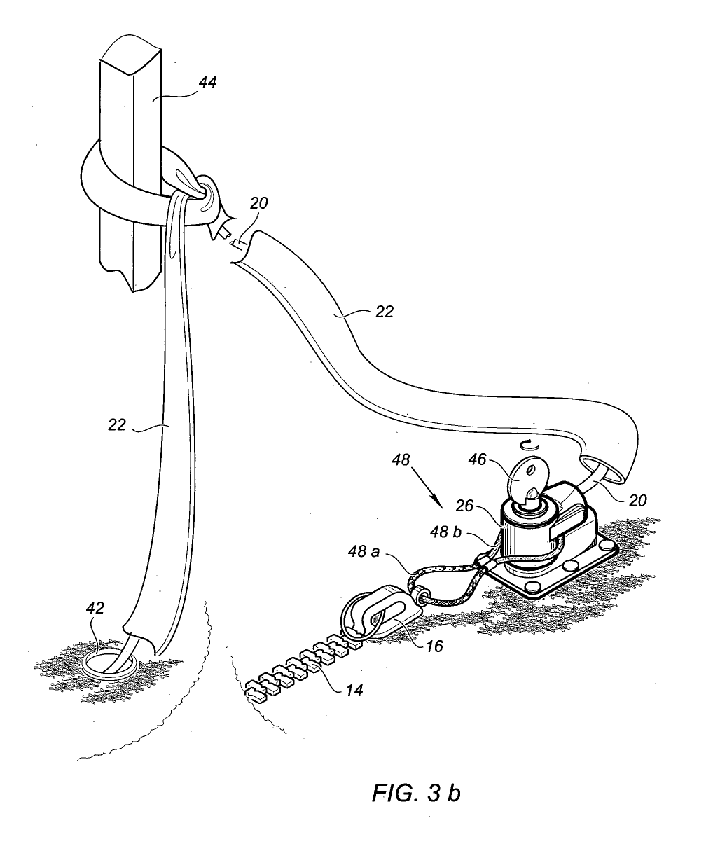

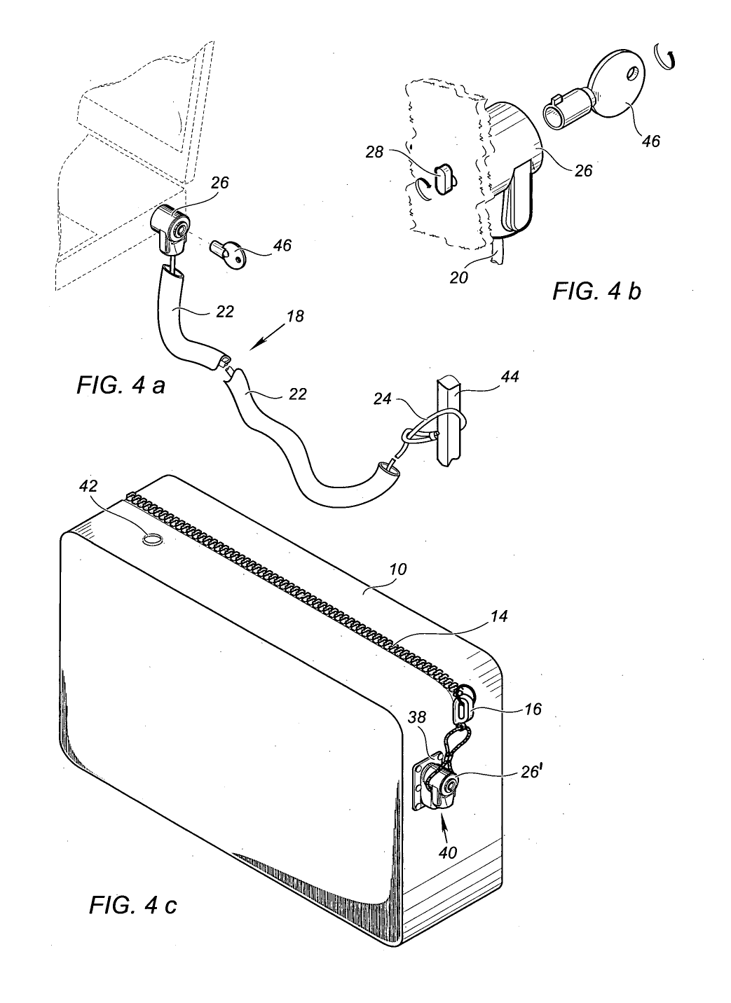

At the other end, a key-operated lock 26 is attached, of any type known per-se, such as the push-button type, provided with a rotatable tip 28 (see FIG. 4b) insertable into a designated slot 30 (as seen in FIG. 3a). A first base plate 32, made of a rigid material such as sheet metal, is fastened, e.g. by rivets 34 to the inside of a side-wall of the bag 10, configured to support a latch-ring 36 of any conventional type.

A second base plate 38 is riveted to an outer, opposite side-wall of the bag 10. As best seen in FIG. 3a, the plate 38 is associated with a protruding, saddle-shaped seat member 40 comprising a pair of ridged portions 40a and 40b and a flat, somewhat elevated portion 40c (namely defined a hollow thereunder) around the designated, rectangular slot 30.

The strap 18 extends through eyelet 42 from the inside of the bag 10 (latch-ring 36 in FIG. 1) to the outside, where it is first tied around an immovable object such as table-leg 44, and then locked by the device 26 against base-plate 38 (rotating the tip 28 behind the slot 30). It will be thus understood that the function of the ridges 40a and 40b is to prevent a rotational movement of the lock body 26 as a whole by 900, thereby enabling the release of the body in the “locked” position. Moreover, the structure of the saddle-shaped seat member 40 is such that it bears the weight of the bag during carrying on the shoulder of the user, rather than applying the load on the T-shaped tip alone.

Further comprised is a double-looped, strong wire 48. One loop 48a is connected to the zipper-rider 16, while the other 48b is big enough to embrace the body of the lock 26, as seen in FIG. 3b.

Obviously, the double-looped wire arrangement is but one out of many equivalent design options.

The use of the invention as so far exemplified is self-explanatory. Let us assume that the owner of the laptop computer carrying bag 10 takes, for example, a seat in a restaurant and wants to make sure that the bag stays where it is left, namely at the side or under his/her table. If the bag is carried on ones shoulder, he/she should first unlock the lock 26, wind or otherwise tie the shoulder-strap 22 around the table-leg 44 or any other accessible fixed object (see FIG. 1), and re-lock the lock 26 through the loop 48b. Thus, the bag 10 as a whole stays protected, including the computer 12 stored therein.

According to another, important aspect of the present invention, the shoulder-strap 18 can be used separately the same way as conventional security cables are used, as depicted in FIGS. 4a and 4b. In this case, the bag can also be secured against unauthorized opening (not against theft), by using another locking device 26′, as depicted in FIG. 4c.

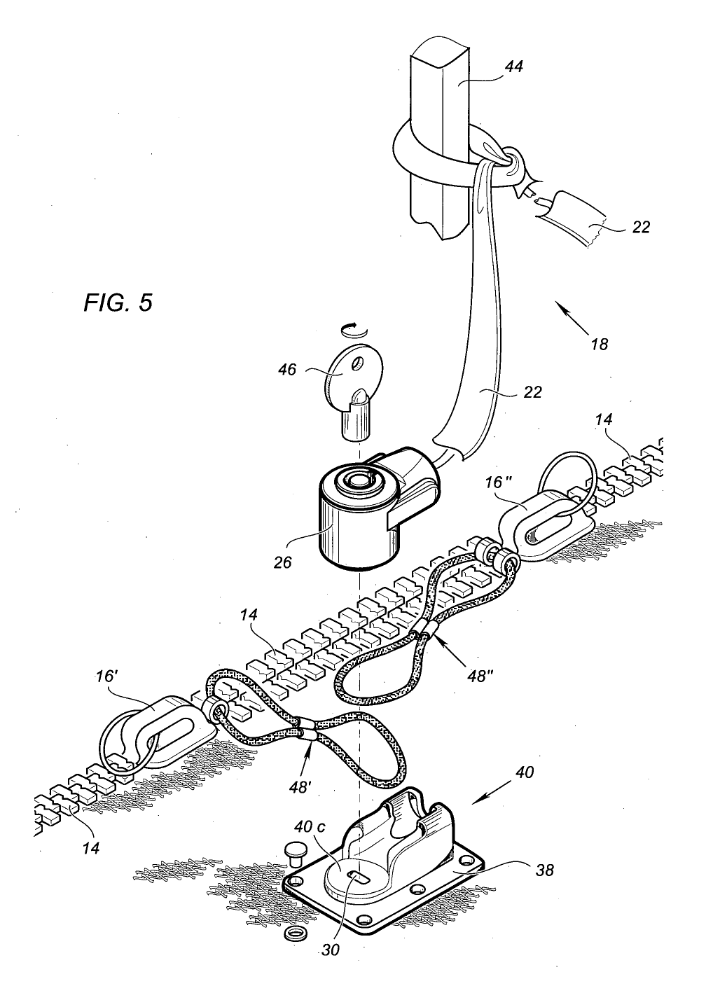

Finally, FIG. 5 differs from FIG. 3a only in that the zipper 14 is provided with two zipper-riders 16′ and 16″ as frequently found in commercial carrying bags.

In such cases, the two riders, each with its double-looped wire 48′ and 48″, are brought together down to the location where the second base plate 38 is mounted, and the lock 26 is used to hold them together the same way as in the former embodiment.

Those skilled in the art to which this invention pertains will readily appreciate that numerous changes, variations and modifications can be effectuated without departing from the true spirit and scope of the invention as defined in and by the appended claims.

1. A carrying bag with a shoulder-strap and a zipper with at least one zipper-rider for closing/opening the bag, the shoulder-strap being provided with a loop at one end and a key-operated locking device at the other end thereof, means for fastening the loop to an inside wall of the bag, and means for securing said at-least one zipper-rider by said locking device to an outside wall of the bag for preventing the un-zipping of the bag.

2. The bag of claim 1 wherein the locking device comprises a T-shaped tip rotatable by a key between locked and unlocked positions, said securing means comprise a rigid, plate-like member, having a slot through which the said tip is adapted to be passed and rotated into the locked position.

3. The bag of claim 2 wherein the shoulder-strap is strengthened against cutting by a cutting tool.

4. The bag of claim 3 wherein the shoulder-strap is strengthened by durable fibers woven to the material of the strap.

5. The bag of claim 3 wherein the shoulder-strap comprises a sheath and a steel cable passed therethrough.

6. The bag of claim 3 wherein the shoulder-strap is passed through an eyelet installed at a top-wall of the bag.

7. The bag of claim 1 wherein the said fastening means are manually releasable.

8. The bag of claim 2 wherein the said zipper-rider securing means comprise a wire loop connected to the rider and adapted to be tied by said locking device to the plate-like member.

9. The bag of claim 2 wherein the T-shaped tip is configured to be locked against a designated slot of commercially available portable computers.

10. A carrying bag having opposite side-walls and a shoulder strap comprising:—
a zipper with zipper-rider for opening/closing the bag by running the zipper-rider from one side-wall to the other side-wall and vise-versa;
the shoulder-strap being detachable from the bag and comprising:—
means for securing one end thereof internally to one side-wall;
key-operated locking means provided at the other end for externally locking the shoulder-strap to the other side-wall; and
means for tying the zipper-rider to the locking means whereby un-zipping of the bag is prevented by the locking means.

11. The bag of claim 10 wherein the locking means comprise:—
a support member rigidly attached to said other side-wall formed with a rectangular security slot; and
a lock body with a key-operated rotatable T-shaped tip, insertable through the security slot, whereby the lock body becomes arrested against the support member through rotation of the tip by about 90°.

12. The bag of claim 11 wherein the said one end of the shoulder strap is formed with an integral loop, whereby the shoulder-strap becomes effectively used for securing laptop computers with designated slot at a side-wall thereof.
